(19) United States
(12) Patent Application Publication
(10) Pub. No.: US 2026/0189374 A1
(43) Pub. Date: Jul. 2, 2026

(54) Method and System for determining a cryptographic key

(71) Applicant: Multiverse Computing S.L., DONOSTIA / SAN SEBASTIÁN (ES)

(72) Inventors: Roman Orus, DONOSTIA (ES); Borja Aizpurua, DONOSTIA (ES); Sukhbinder Singh, DONOSTIA (ES); Saeed Jahromi, DONOSTIA (ES)

(21) Appl. No.: 19/284,077

(22) Filed: Jul. 29, 2025

(30) Foreign Application Priority Data
Dec. 31, 2024 (EP) 24 383 492

(51) Int. Cl. H04L 9/08

(52) U.S. Cl. CPC H04L 9/0852

(57) ABSTRACT

The present invention proposes a computer implemented method and system for determining a cryptographic key. The method comprises constructing a tensor network with parameters representing a candidate cryptographic key; adjusting the parameters of the tensor network; generating a candidate key sample and obtaining a candidate ciphertext obtained with the candidate cryptographic key; calculating a cost function with respect to a target ciphertext, measuring an overlap between the target ciphertext and the candidate ciphertext, determining whether the overlap has reached a threshold value. If threshold value is not reached, repeating the method by further adjusting the parameters of the tensor network, if the threshold value is reached, determining that the candidate cryptographic key is the cryptographic key.

### CROSS-REFERENCE TO RELATED APPLICATIONS

The present application claims priority to European patent application EP 24 383 492.6, filed 31 Dec. 2024, the entire content thereof being incorporated by reference.

### BACKGROUND OF THE INVENTION

### Field of the Invention

The field of the invention relates to a computer implemented method and system for determining a cryptographic key.

### Brief Description of the Related Art

Maintaining security of information is required in various sectors, including but not limited to defence, finance, and personal privacy. Currently, cryptographic protocols are commonly used to secure sensitive data by transforming plain text into encrypted ciphertext using a cryptographic key. Traditionally, attackers have employed brute-force attacks or sophisticated algorithms to recover these cryptographic keys. However, with the advent of quantum computing, the threat to current cryptographic protocols has increased due to quantum algorithms like Shor's and Grover's, which can break current encryption protocols faster than using classical methods.

Currently, there are limitations on the use of quantum computer to their current applicability due to noisy intermediate-scale quantum (NISQ) hardware. The NISQ hardware is characterized by a limited number of qubits and other performance bottlenecks. Quantum-inspired approaches, like variational quantum algorithms (VQAs), have been developed to address these constraints. These approaches still rely on quantum hardware, which remains a significant barrier due to high costs and operational complexity.

One example of a cryptographic protocol is the Simplified Data Encryption Standard (S-DES) The S-DES, or Simplified Data Encryption Standard is a cryptographic protocol designed to provide a basic understanding of symmetric-key cryptography. The S-DES protocol operates on 8-bit blocks of data using a 10-bit key and employs a series of permutation and substitution techniques to transform plaintext into ciphertext and vice versa. A brute-force attack to attempt to decrypt the ciphertext requires an average of 512 iterations. In the brute-force attack, every possible key is tried until the correct key is found. Given that the S-DES protocol uses a 10-bit key, there are 210=1024 possible keys, and on average, half of these (512) would need to be tested to find the correct key.

Another example of an encryption standard is the Simplified Advanced Encryption Standard (S-AES) which is an educational adaptation of the widely used Advanced Encryption Standard (AES) algorithm S-AES simplifies key components of the encryption process. The S-AES algorithm operates on small data blocks, typically of 16 bits, and uses shorter key lengths compared to the regular AES algorithm and employs substitution-permutation to transform plaintext into ciphertext and vice versa.

Blowfish is another symmetric-key block cipher encryption algorithm which is known for its simplicity and efficiency. The Blowfish encryption algorithm operates on fixed-size blocks of data and supports key lengths ranging from 32 bits to 448 bits, making the Blowfish encryption algorithm adaptable to various security requirements. Its key setup phase is notably fast, enabling rapid encryption and decryption processes. Despite its age, Blowfish remains widely used and respected due to its robust security features and speed. Its open design and absence of any licensing restrictions have contributed to its popularity in both commercial and open-source applications. The algorithm's resilience against various cryptanalytic attacks has solidified its reputation as a reliable choice for secure data encryption. To date, no effective cryptanalysis has been found to date for Blowfish, with the brute-force attacks being the standard method. Although the Blowfish encryption algorithm cipher is believed to be weak against birthday attacks, these are also the brute-force collision attacks based on the so-called birthday paradox.

A number of publications and patent documents are known that address the issues of breaking cryptographic protocols. For Example, the preprint “Hacking Cryptographic Protocols with Advanced Variational Quantum Attacks”, by Borja Aizpurua et al., arXiv:2311, published on 15 Apr. 2023 and available at https://arxiv.org/abs/2311.02986 (downloaded 21 Oct. 2024). This paper introduces the Variational Quantum Attack Algorithm (VQAA) for hacking cryptographic protocols using quantum circuits.

U.S. patent application Ser. No. 18/088,042, filed on 16 May 2024 and entitled “Variational Quantum Attack for Cryptographic Protocol” focuses on using quantum circuits for cryptographic key recovery via VQAA. The method proposed in this patent draft uses Tensor Networks instead of quantum circuits.

U.S. patent application Ser. No. 18/106,555 “Method and System for Modifying Document Without Changing Hash Value” filed on 8 Aug. 2024 teaches a method recovering plaintext from a hashed message using quantum circuits for the recovery process.

U.S. patent application Ser. No. 18/375,714 entitled “Method and System for Modifying Document Without Changing Hash Value”, filed on 8 Aug. 2024, teaches the use of a Tensor Network approach which can be implemented on classical hardware to recover plaintext from a hashed message. This approach offers a more efficient and cost-effective alternative to quantum solutions for cryptographic attacks on encrypted messages.

### BRIEF SUMMARY OF THE INVENTION

There is a need to develop a classically implementable, yet efficient, method to attack the afore-mentioned cryptographic protocols without relying on the quantum hardware. The method set out in this application leverages Tensor Networks (TN) such as Matrix Product States (MPS) and Flexible-PEPS Quantum Circuit Simulators (FQCS) and offers a new approach to improve the efficiency of cryptographic attacks, especially for symmetric-key cryptography, while bypassing the need for quantum processors. The goal is to simulate quantum-like attacks on classical hardware, significantly enhancing the performance of cryptanalysis in practical and scalable ways.

A method for determining a cryptographic key in a key space for encrypting a plain text to a corresponding encrypted ciphertext is disclosed in this application. The method comprises constructing a tensor network based on the encrypted ciphertext, encoding the key space into a Matrix Product State (MPS) or Flexible-PEPS Quantum Circuit Simulator (FQCS), simulating an encryption process to obtain a simulated superposition of ciphertexts, and determining an overlap between the simulated superposition of ciphertexts and the encrypted ciphertext. Upon reaching a predetermined overlap value for the overlap, the key space is collapsed to determine the encryption key, or otherwise, parameters of the tensor network are adjusted.

Projected Entangled Pair States (PEPS) are a class of tensor network states used in quantum many-body physics and quantum information theory to describe quantum states of systems on a lattice. Each lattice site is associated with a tensor, and the entanglement structure of the quantum state is encoded in the connections (or indices) between these tensors.

Flexible PEPS are an extension or generalization of the standard PEPS framework designed to enhance their adaptability and efficiency in describing quantum states, particularly in systems with irregular geometries, inhomogeneities, or specific physical constraints.

The present document proposes a method for determining a cryptographic key, the method comprising the steps of constructing a tensor network with parameters representing a candidate cryptographic key; adjusting the parameters of the tensor network; generating a new candidate key sample and obtaining a candidate ciphertext obtained with the candidate cryptographic key; calculating a cost function with respect to a target ciphertext; measuring an overlap between the target ciphertext and the candidate ciphertext, determining whether the overlap has reached a threshold value is reached; and if threshold value is not reached, repeating the method by further adjusting the parameters of the tensor network, if the threshold value is reached, determining that the candidate cryptographic key is the cryptographic key.

A system for determining a cryptographic key is also proposed. The system comprises at least one input/output device for inputting a cyphertext and outputting the cryptographic key; at least one tensor network with parameters representing a candidate cryptographic key; an optimiser for adjusting the parameters of the at least one tensor network by classical optimisation; and a comparator for determining an overlap between the target ciphertext and the candidate ciphertext.

The present document describes a computer system for determining a cryptographic key, the computer system comprising a classical processor configured to: construct a tensor network with parameters representing a candidate cryptographic key; adjust the parameters of the tensor network; generate a new candidate key sample and obtaining a candidate ciphertext obtained with the candidate cryptographic key; calculate a cost function with respect to a target ciphertext; measure an overlap between the target ciphertext and the candidate ciphertext, determine whether the overlap has reached a threshold value is reached; and if threshold value is not reached, repeat the method by further adjusting the parameters of the tensor network, if the threshold value is reached, determine that the candidate cryptographic key is the cryptographic key.

A computer program product comprising logic for executing, by means of a classical processor, a method for determining a cryptographic key, the method comprising the steps of constructing a tensor network with parameters representing a candidate cryptographic key; adjusting the parameters of the tensor network; generating a new candidate key sample and obtaining a candidate ciphertext obtained with the candidate cryptographic key; calculating a cost function with respect to a target ciphertext; measuring an overlap between the target ciphertext and the candidate ciphertext, determining whether the overlap has reached a threshold value is reached; and if threshold value is not reached, repeating the method by further adjusting the parameters of the tensor network, if the threshold value is reached, determining that the candidate cryptographic key is the cryptographic key.

### BRIEF DESCRIPTION OF THE FIGURES

For a more complete understanding of the present invention and the advantages thereof, reference is now made to the following description and the accompanying drawings, in which:

FIG. 1 shows an overview of a computing system for implementing the method of this document.

FIG. 2 shows an overview of a method of this document.

FIG. 3 shows an overview of a system of this document

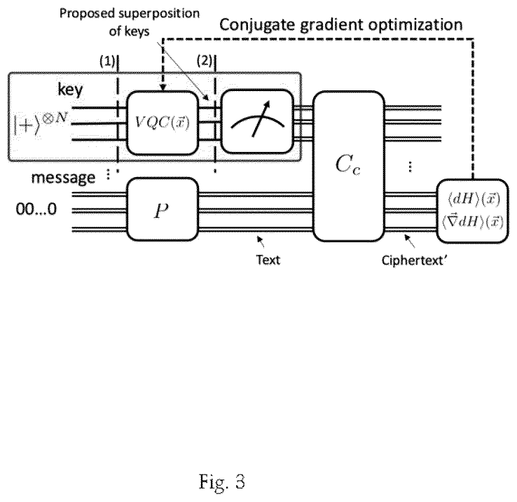

FIG. 4 shows a flow diagram of a method of this document

### DETAILED DESCRIPTION OF THE INVENTION

The invention will now be described on the basis of the drawings. It will be understood that the embodiments and aspects of the invention described herein are only examples and do not limit the protective scope of the claims in any way. The invention is defined by the claims and their equivalents. It will be understood that features of one aspect or embodiment of the invention can be combined with a feature of a different aspect or aspects and/or embodiments of the invention.

This document describes a method for cryptographic key recovery using Tensor Network (TN) techniques. The method utilizes Matrix Product States (MPS) and Flexible-PEPS Quantum Circuit Simulators (FQCS) to recover cryptographic keys more efficiently on classical hardware and does not require the use of quantum hardware. It has been found that this method applies to any cryptographic protocol, but the method has demonstrated particularly high effectiveness in symmetric-key cryptography.

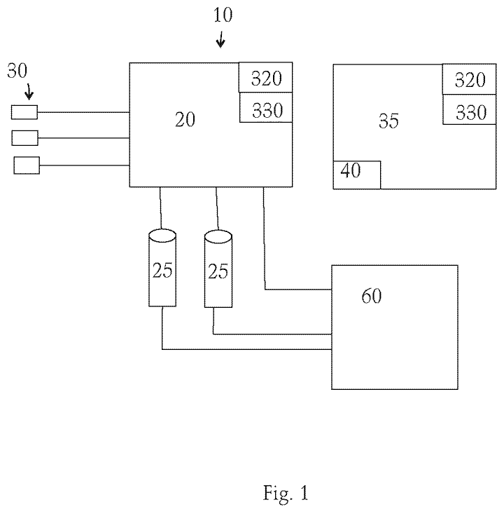

FIG. 1 shows an overview of a typical system which can be used for performing the method set out in this document. FIG. 1 shows an overview of a computing system 10 for implementing the method of this document. The computing system 10 comprises, in an example, a classical central processing unit 20 which is connected to a data storage unit 25 (i.e., one or more memory devices), and a plurality of input/output devices 30. The input/output devices 30 enable input of one or more values for parameters of a tensor and an output of a result, such as a cryptographic key obtained from the tensor, as will be explained later.

A graphics processing unit 35 for processing vector calculations and a field programmable gate array (FGPA) 40 for control logic that can also be connected to the central processing unit 20. The central processing unit 20 and/or the graphics processing unit 35 have an optimiser 320 for optimising parameters of a tensor and a comparator 330 for determining the cryptographic key, as will be explained later.

The computing system 10 may be connected to a computer network 60, such as the Internet. It will be appreciated that the computing system 10 of FIG. 1 is merely exemplary and other units or elements may be present in the computing system 10. It will also be appreciated that there may be many input/output (I/O) devices 30 located at multiple locations and that there may be a plurality of data storage units 25 also located at multiple locations. The many I/O devices 30 and data storage units 25 are connected by the computer network 60.

The method set out in this document is implemented in the computing system 10 shown in FIG. 1. The method leverages the compression and optimization capabilities of tensor networks (TN) and thereby reduces the exponential computational requirements of the computing system 10 when carrying out brute-force attacks to recover a cryptographic key. The classical implementation of these TN methods can outperform quantum-inspired approaches by avoiding the need for hardware-dependent quantum simulators. This makes TN-based methods both practical and powerful for attacking cryptographic protocols of varying complexity

The method can use two types of Tensor Networks (TN), specifically Matrix Product States (MPS) for smaller sizes of the cryptographic keys, and Flexible-PEPS (Projected Entangled Pair States) for larger and more complex key spaces of the cryptographic keys. The TN methods enable handling of large-scale data by compressing the data and minimizing the computational resources required to explore large key spaces. Unlike brute-force methods, which scale exponentially with key size, the TN methods set out in this document reduce the dimensionality of the problem through efficient representation and optimization of the key space.

The method can be applied to both symmetric and asymmetric cryptographic protocols. The method has been tested on symmetric-key protocols like S-DES, S-AES, and Blowfish. These symmetric-key protocols are used for example for data transmission.

The Tensor Network-based method for the recovery of the cryptographic keys provides a more efficient alternative by constructing a tensor network that represents the encrypted ciphertext and the potential key combinations of the cryptographic keys. It has been demonstrated to outperform brute-force methods, especially in large and complex key spaces. As the key sizes and complexity increase, the TN-based methods remain computationally feasible, reducing the search space and accelerating key recovery of the cryptographic keys even for larger cryptographic protocols like Blowfish, where brute-force methods become prohibitively expensive.

The method uses, in one aspect, the concept of Matrix Product States (MPS) for the recovery of small cryptographic keys. Such small cryptographic keys are used in protocols like the Simplified Data Encryption Standard (S-DES). The MPS is a one-dimensional tensor network that can efficiently represent quantum states. In this aspect, the MPS directly represents the cryptographic key space, and, by iteratively adjusting the parameters of the tensor network, an algorithm can rapidly converge on the correct cryptographic key. The MPS optimization process involves adjusting bond dimensions and internal parameters to maximize an overlap with the correct ciphertext, allowing the recovery of the cryptographic keys using fewer computational resources than traditional methods. This algorithm will be explained in more detail later in this document.

Flexible-PEPS Quantum Circuit Simulators (FQCS) are used for larger cryptographic keys, such as those cryptographic keys used in the Blowfish protocol. The PEPS are two-dimensional tensor networks which makes the PEPS suitable for representing more complex systems with higher-dimensional data. The FQCS method simulates the behaviour of quantum circuits without requiring any quantum hardware and thus enables efficient recovery of the cryptographic keys even in large key spaces. By optimizing the tensor network to maximize the overlap between the simulated and actual ciphertexts, the FQCS allows for the recovery of cryptographic keys in larger, more complex protocols, demonstrating higher efficiency than brute-force attacks.

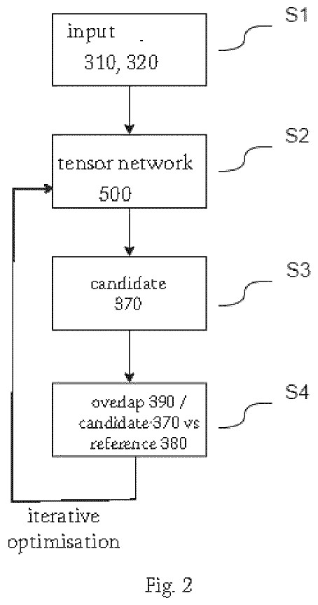

A description of the method for determining a cryptographic key will now be given in conjunction with FIG. 2. Let us suppose that an attack on an encryption standard is to be carried out in order to decode an encrypted ciphertext and recover a plaintext. A candidate cryptographic key is encoded into the MPS.

The encryption standard can be the S-DES encryption standard, and the candidate cryptographic key can be a 10-bit cryptographic key of the S-DES standard.

Plaintexts are texts which have been encrypted using the candidate cryptographic key. It will be appreciated that the plaintexts are any sets or combination of data that is presented in an unencrypted form. A superposition of possible one of the plaintexts results in an encrypted ciphertext.

The method starts with the construction of a tensor network 500 representative of a candidate ciphertext obtained by the candidate cryptographic key 310. The tensor network 500 comprises a set of tensors. One non-limiting example would be to create a tensor for each character of the cryptographic key.

The goal is to adjust the tensors by optimising internal parameters of the tensors within the MPS to maximize an overlap 390 between a simulated ciphertext 370, i.e. a candidate ciphertext obtained with the candidate cryptographic key 310, and a reference ciphertext 380. The simulated ciphertext is the data which is obtained by encrypting the known plaintext using a sampled candidate cryptographic key from the superposition of possible key.

Once the tensor network 500 is constructed, the determination process of the cryptographic key begins by optimizing internal parameters of the tensor network 500 (step S2). This involves adjusting bond dimensions, applying techniques like Singular Value Decomposition (SVD) to efficiently modify the tensor network 500, and using classical 30 optimization methods, such as Adam optimization, to update the tensors of the tensor network 500.

For MPS, the optimization process involves sweeping through the tensor network 500 from left to right and back, adjusting the tensors sequentially. In Flexible-PEPS, the optimization is more complex due to the higher dimensionality but follows a similar iterative process.

During each iteration, the candidate cryptographic key 310 is changed and a candidate ciphertext 370 is generated. The candidate ciphertext 370 can be compared with a reference ciphertext 380 in a comparator 360. The comparator 360 measures an overlap, using Hamming distances, between the reference ciphertext 380 and the candidate ciphertext 370.

The overlap 390 is used as a criterion to determine whether the correct cryptographic key has been found. If the overlap 390 reaches a pre-determined threshold (e.g., minimal Hamming Distance), the algorithm concludes that the correct cryptographic key has been recovered (or at least substantially recovered). If the overlap 390 is below the pre-determined threshold, the parameters of the tensor network 500 are further adjusted via a classical optimization algorithm 390 in the classical central processing unit 20.

The optimization algorithm is used to adjust the input parameters of the tensor network 500 to arrange for the candidate ciphertext 370 to have an overlap 390 with the reference ciphertext in step S4. The overlap occurs when the Hamming distance is zero (or very close to zero). The iterative process continues until the correct plaintext is revealed.

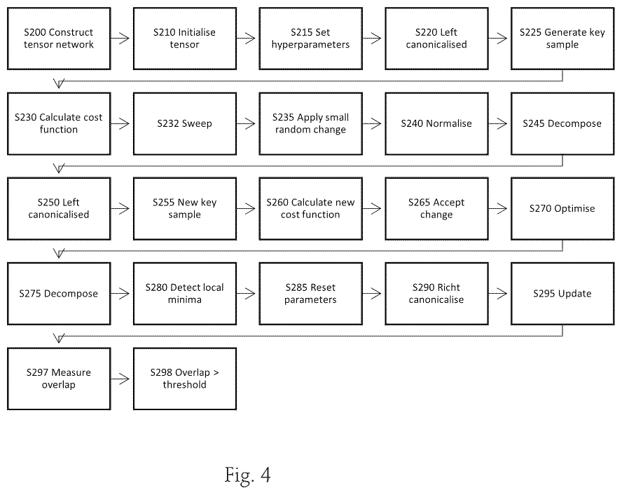

The construction and optimization of the tensor network is outlined with reference to FIG. 4 for MPS showing a flow diagram of the method of this document.

The first step S200 in the method involves constructing a tensor network representation of the encrypted ciphertext and key space. In the case of the Matrix Product States (MPS), the tensor network 500 comprises a series of tensors, in which each tensor represents a possible bit in the cryptographic key. The MPS is defined as:

$$\vert ψ 〉 = {\sum }_{{i}_{1} , {i}_{2} , … , {i}_{N}} {A}^{{i}_{1}} {A}^{{i}_{2}} ⋯ {A}^{{i}_{N}} \vert {i}_{1} {i}_{2} ⋯ {i}_{N} 〉$$

A^{ik} are tensors associated with each site k=1, 2, . . . , N, and the indices iₖ represent the physical states at each site.

The MPS network is initialized in step S210 with random values for the tensor parameters. An algorithm is now deployed to iteratively update the tensors in the MPS network to converge on the correct cryptographic key.

In a next step S215, hyperparameters of the MPS are set. The hyperparameters are parameters that control the structure of the MP. Example of the hyperparameters include: BondDim (virtual bond dimension of the MPS), step length (learning rate for parameter updates, steps (number of sequential updates for the same tensor in each iteration), cutoff value (threshold for discarding smaller eigenvalues in Singular Value Decomposition (SVD)), reset value (threshold for detecting local minima and resetting parameters), and temperature (acceptance criterion for unfavourable changes).

In the next step S220, the MPS is left canonicalized and a key sample (i.e. candidate cryptographic key) for the cryptographic key is generated in step S225 by sampling the MPS. A cost function is then calculated in Step S230 by using the Hamming Distance. This generation of the cost function will be explained in more detail later. A sweep is then carried out in step S232 under which, for each tensor from the right-most tensor to the left-most tensor, the current tensor is merged with its neighbouring tensor to form a combined matrix, called merged matrix. The merged matrix is updated in step S235 by applying a random change, normalized in step S240, and then decomposed in step S245 back into the original tensors via SVD.

The change is a small random change, which is applied to the elements of the merged matrix, with different elements receiving different perturbations. The energy difference (ΔE\Delta E) is then calculated to evaluate the impact of this modification on the cost function. Based on the Metropolis-Hastings criterion, the change is accepted if ΔE<0\Delta E<0 or, if ΔE≥0\Delta E\geq 0, with a probability proportional to exp [symbol] (−ΔE/T)\exp(−\Delta E/T), where T is the temperature parameter. If accepted, the updated matrix is normalized (step S240) and decomposed back into the original tensors via Singular Value Decomposition (SVD) in step S245; otherwise, the matrix reverts to its previous state, and the algorithm proceeds.

In a next step S250, the MPS is left canonicalized to ensure numerical stability and proper normalization. A new key sample is generated in step S255 by sampling through the MPS. In a step S260, the cost function, specifically the Hamming Distance, is recalculated using the new sampled key. If the ciphertext generated with the new key is closer to the target ciphertext, the change is deemed favourable and accepted in step S265. If the change is not favourable, it is accepted with a probability determined by the Metropolis-Hastings criterion, allowing the algorithm to explore the solution space and avoid being trapped in local minima the probability is given

$$P ( Δ E , T ) ∝ exp ( - \frac{Δ E}{T} )$$

In which T the temperature and ΔE is represents the change in the cost function that results from applying a random change to the system. Specifically:

$$Delta E = Costnew - Costold$$

where:
Costnew is the value of the cost function (e.g., the Hamming Distance) calculated using the new key or state after the random change.
Costold is the value of the cost function before the random change was applied.

It is noted simply ignoring the random change could lead to be stuck in a local minima. It is favourable to o avoid local minima especially in complex, high-dimensional optimization landscapes.

An Adam optimizer is applied in step S270 to update the merged matrix by calculating gradients and update parameters of the MPS to which the change was applied, and only if the change was accepted. The updated merged matrix is normalized and decomposed in step S275 back into the original tensors via SVD.

In the next step S280, gradient norms of the gradients from the changes to all the parameters of the tensors of the MPS, here the 2 tensors of the 2-site MPS update, are monitored to detect local minima and, if the local minima are detected, then the parameters are reset in step S285.

First and second moments of the gradients can be used. The first and second moments of the gradients refer to statistical summaries used in optimization. The first moment is the mean (average) of the gradients, which captures the direction of the optimization path. The second moment is the uncentered variance (mean of squared gradients), which captures the scale of gradient changes and helps adapt learning rates. The absolute value of the gradients provides a simple measure of gradient magnitude at each step.

The gradient norm quantifies the overall size of the gradient vector, typically via L2 norm (i.e., the square root of the sum of squared gradients). It is used to monitor convergence and detect local minima. These metrics are used, for instance, in the Adam optimizer to adaptively update parameters during the iterative adjustment of the tensor network.

The MPS is then right canonicalized in step S290 and the sweep is updated in step S295 sweeping from left to right. The left-to-right and the right-to-left sweeps are iterated until the target cryptographic key is found. During each iteration, the tensor network generates a sample cryptographic key by simulating the encryption process and comparing the resulting simulated ciphertext from the simulated encryption process to the actual (target) ciphertext. The cost function, such as the Hamming Distance between the generated ciphertext and the actual/target ciphertext, guides the optimization process, allowing the algorithm to focus on the key samples that are closer to the correct solution.

The key step S297 in the method is to measure the overlap between the simulated ciphertext generated by the tensor network and the actual/target ciphertext. The algorithm computes this overlap after each iteration and uses the valued of the overlap as a criterion to determine in step S298 whether the correct cryptographic key has been found. If the overlap reaches a pre-determined threshold, the algorithm concludes that the correct cryptographic key has been recovered. If the value of the overlap is below the pre-determined threshold, the parameters of the tensor network are further adjusted until the target cryptographic key is found.

For larger sizes of the cryptographic key, the Flexible-PEPS is used, as noted above. The Flexible-PEPS extends the tensor network to two dimensions and adjusts the network's geometry based on the complexity of the key and the ciphertext and deletes less relevant connections based on bond entanglement entropy (BEE). This adaptability reduces the computational burden, allowing for the simulation of larger systems. The FQCS method simulates quantum circuits with high accuracy, even in the absence of quantum hardware, making it ideal for larger cryptographic key recovery problems.

The tensor network can be extended by adding new edges (bonds) between tensors to reflect potential correlations in the unknown cryptographic key. Each added edge represents a possible interaction or dependency between parts of the variable string. If a tensor exceeds a set number of connections (a cutoff x), the least relevant edge is removed. The least relevant edge is determined based on a measure of bond importance. This allows keeping efficient while adapting to the complexity of the message.

The PEPS network can adjust dynamically, deleting less relevant connections between the tensors in the tensor network, while retaining significant connections, making the process computationally efficient even for large, hashed messages. More precisely, the PEPS network can adjust dynamically by monitoring the number of connections (bonds) per tensor. If a tensor exceeds a preset limit (cutoff x), the network removes the least relevant connection to maintain efficiency. A connection is considered less relevant if the connection carries low bond entanglement entropy, meaning it contributes little to the overall correlation in the data. The term dynamic means that the geometry of the network is not fixed, i.e. that connections are added or removed during runtime based on ongoing evaluations of importance, allowing the network to adapt to the structure of the hashed message.

The method set out in this document focuses primarily on symmetric-key cryptography. However, the methods described can be extended to all cryptographic protocols. For asymmetric protocols, the tensor networks can be adapted to explore key spaces where the encryption and decryption keys are distinct, providing a new pathway for attacking public-key systems without requiring quantum resources.

This invention introduces a powerful cryptographic attack method that leverages tensor networks to recover encryption keys with improved efficiency and scalability. By enabling classical simulation of quantum-like attacks, it overcomes many of the limitations of existing quantum cryptanalysis methods. The use of MPS and Flexible-PEPS allows for performance improvements in both small and large cryptographic systems, making it a versatile and valuable tool for modern cryptanalysis.

### REFERENCE NUMERALS

10 Computing System
20 Central processing unit (CPU)
25 Data storage unit
30 Input/output devices
35 Graphics processing unit (GPU)
40 Field programmable gate array
60 Computer network
310 Tensor network
320 Optimiser
330 Comparator

What is claimed is:

1. A computer implemented method for determining a cryptographic key, the method comprising:
constructing a tensor network with parameters representing a candidate cryptographic key;
adjusting the parameters of the tensor network;
generating a candidate key sample and obtaining a candidate ciphertext obtained with the candidate cryptographic key;
calculating a cost function with respect to a target ciphertext;
measuring an overlap between the target ciphertext and the candidate ciphertext;
determining whether the overlap has reached a threshold value; and
if threshold value is not reached, repeating the method by further adjusting the parameters of the tensor network, if the threshold value is reached, determining that the candidate cryptographic key is the cryptographic key.

2. The method of claim 1, wherein the cost function is based on a Hamming Distance between the simulated ciphertext and the target ciphertext.

3. The method of claim 1, wherein the adjusting of the parameters of the tensor network comprises applying a random change to the parameters of the tensor network, wherein the random change has a magnitude of 1 to 1e-4.

4. The method of claim 1, wherein the adjusting of the parameter of the tensor network comprises one of left canonicalising or right canonicalising the tensor network.

5. The method of claim 1, wherein the adjusting of the parameters of the tensor network comprises sweeping the tensor network to create a merged matrix.

6. The method of claim 5, wherein the random change is applied to the merged matrix.

7. The method of claim 5, further comprising optimising the merged matrix.

8. The method of claim 5, further a step of decomposing the merged matrix.

9. The method of claim 1, further comprising determining local minima.

10. The method of claim 1, wherein the tensor network is implemented as one of a matrix product states or a flexible projected entangled pair state.

11. A system for determining a cryptographic key, comprising:
at least one input/output device for inputting a cyphertext and outputting the cryptographic key;
at least one tensor network with parameters representing a candidate cryptographic key;
an optimiser for adjusting the parameters of the at least one tensor network by classical optimisation; and
a comparator for determining an overlap between the target ciphertext and the candidate ciphertext.

12. The system of claim 11, wherein the at least one tensor network is implemented as one of a matrix product states or a flexible projected entangled pair state.

13. Computer system for determining a cryptographic key, the computer system comprising a classical processor configured to:
construct a tensor network with parameters representing a candidate cryptographic key;
adjust the parameters of the tensor network;
generate a new candidate key sample and obtaining a candidate ciphertext obtained with the candidate cryptographic key;
calculate a cost function with respect to a target ciphertext;
measure an overlap between the target ciphertext and the candidate ciphertext,
determine whether the overlap has reached a threshold value is reached; and
if threshold value is not reached, repeat the method by further adjusting the parameters of the tensor network, if the threshold value is reached, determine that the candidate cryptographic key is the cryptographic key.

14. A computer program product comprising logic for executing, by means of a classical processor, a method for determining a cryptographic key, the method comprising the steps of:
constructing a tensor network with parameters representing a candidate cryptographic key;
adjusting the parameters of the tensor network;
generating a new candidate key sample and obtaining a candidate ciphertext obtained with the candidate cryptographic key;
calculating a cost function with respect to a target ciphertext;
measuring an overlap between the target ciphertext and the candidate ciphertext;
determining whether the overlap has reached a threshold value is reached; and
if threshold value is not reached, repeating the method by further adjusting the parameters of the tensor network, if the threshold value is reached, determining that the candidate cryptographic key is the cryptographic key.
